(19) United States
(12) Patent Application Publication
(10) Pub. No.: US 2002/0153189 A1
(43) Pub. Date: Oct. 24, 2002

(54) Seatbelt tensioner firing loop

(76) Inventor: James M. Young, Brighton, MI (US)

Correspondence Address: Jacques M. Dulin, Esq., Innovation Law Group, Ltd., Suite 101, 851 Fremont Ave., Los Altos, CA, 94024, US

(21) Appl. No.: 09/841,916

(22) Filed: Apr. 23, 2001

(51) Int. Cl. B60R 22/46; B60R 21/16

(52) U.S. Cl. 180/268; 280/806; 280/735

(57) ABSTRACT

System and method for selectively withholding or allowing activation of a seatbelt tensioner device, depending upon whether or not a seatbelt latch or other latchable instrument is closed. The system includes an electrical circuit including a first resistor in series with a shunt circuit, the shunt circuit including a second resistor in a first shunt to arm an electrical switch having negligible resistance in a second shunt arm. A first terminal of the circuit is connected to a first terminal of the voltage source. Second terminals of the voltage source and the circuit are connected to first and second terminals of the airbag activation circuit or seatbelt tensioner activator, which are activated only if a current passing through the activation circuit is greater than a selected threshold current. The first and second resistance values are chosen so that this current exceeds the threshold current only when the switch is closed, which occurs only when a seatbelt is latched. A high-side and a low-side switch operate to isolate the voltage source from the system.

### TECHNICAL FIELD

This invention relates to vehicle seatbelt tensioner control systems, and, more particularly, to circuits for determining the state of passenger seatbelt latching to prevent the tensioner squib from firing unless the seatbelt latch is engaged. The inventive circuit can also be integrated in an airbag control system.

### BACKGROUND

Vehicle passenger safety systems include airbags, seatbelts, and occupancy sensor systems that provide “state” information to airbag and seatbelt control systems. In the case of an automobile, the automotive occupancy systems (AOS) may include one or more types of sensors to determine the nature and position of occupants, outputting one or more signals to airbag and/or seatbelt deployment tensioner control devices. These form so-called “smart airbag” systems, in which the deployment of one or more types of airbags, e.g., front, side, curtain, or the like, airbags, is controlled. Examples of control schemes for airbags include: staged fill, slower fill, partial fill to provide “softer” cushioning; sequential or differential fill of different airbags (e.g., side or head curtains before frontal); and the like.

Seat, lap, and chest belts (herein body restraints) also form a first line of safety and are integral to passenger protection. In many instances, airbags do not or should not deploy in certain types of low speed crashes. These body restraints provide protection in such crashes. However, these restraint belts, by their nature, are user friendly to accommodate the variability of passenger size and girth, seasonal clothing variations, passenger comfort, and the like. Thus, in normal use, the belts may be latched, but loose, which condition can permit the user to move a considerable distance during a crash before being restrained. The whiplash effect of suddenly being restrained by “reaching the end of the leash”, so to speak, could conceivably itself contribute an injury, or permit injury to occur before the restraint slack is taken up. Accordingly, current practice is to provide seatbelts with appropriately sized squibs which fire upon signal from the ACM (airbag control module), to reel in the excess slack of the seatbelt, thereby reducing belt injury and making the retention more effective. A squib is a small electric or pyrotechnic device used to ignite a charge. The ACM signal may be internal or external sensor derived, or may be a signal derived from an accelerometer.

The seatbelt tensioner squib system should, however, fire only upon the belt being latched, preferably in place on a passenger. A variety of latch open/closed circuits are available, but each has disadvantages, including possible complexity, power drain, current leakage, unacceptable failure rate, and the like.

### THE INVENTION

Summary, Including Objects and Advantages:

The present invention relates to circuits for controlling the activation of a seatbelt tensioner in a passenger vehicle having an ACM. One embodiment includes a voltage source having first and second terminals with a selected voltage between the two terminals. The voltage source is isolated from the remaining circuit by a high-side and a low-side switch that are controlled by the ACM. A seatbelt tensioner activator in the system includes a squib with a selected first resistance value. A shunt circuit, including an electrical switch, the switch having negligible resistance when the switch is activated and a second resistor having a second resistance value, is connected across the electrical switch, such that the voltage source, high-side switch, the first resistor, the shunt circuit, and the low-side switch are connected in series. When the ACM determines that the seatbelt tensioner should be deployed, it closes both the high-side and the low-side switches. With the switches closed, the seatbelt tensioner activator is connected to the voltage source and the electrical circuit, with the seatbelt tensioner activator being activated only if a current at least equal to a selected threshold current passing through the activation circuit, where the current in the electrical circuit is greater than the threshold current only if the shunt circuit switch is closed.

A further embodiment includes a seatbelt tensioner control system that includes a control module and a power source. A seatbelt latch switch is connected in series with the power source, and also has a first resistor connected across the seatbelt latch switch. A seatbelt tensioner is positioned in series with the control module, the power source, and the seatbelt latch switch, with the seatbelt tensioner having a predetermined internal resistance, the seatbelt tensioner being activated only when the seatbelt latch switch is closed.

Further embodiments are also disclosed including method and process steps for preventing the deployment of a seatbelt tensioner activator, as well as preventing the activation of an associated passenger airbag, and application to airbag squibs.

### BRIEF DESCRIPTION OF THE DRAWINGS

For a more complete understanding of the embodiments of the invention herein, reference may be had to the following detailed description in conjunction with the drawings wherein:

FIG. 1 is a schematic diagram of a typical prior art solution to seatbelt squib firing systems; and

FIG. 2 is a schematic diagram of a seatbelt tensioner firing loop system in accordance with the present invention.

Reference numbers refer to the same or equivalent parts of the present invention throughout the various figures of the drawings.

### DETAILED DESCRIPTION, INCLUDING THE BEST MODE OF CARRYING OUT THE INVENTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

This invention relates to vehicle seatbelt tensioner control systems and circuits for determining the state of seatbelt latching to prevent the tensioner squib from firing unless the seatbelt latch is engaged, normally about a passenger.

Vehicles manufactured and sold in the United States since the mid 1980s are required to provide front seat airbags that are activated when the vehicle experiences a collision. One problem initially encountered was that an airbag for a given seat would be activated in a collision whether or not a vehicle occupant occupied the seat. Similarly, a seatbelt tensioner system could, as well, be activated needlessly if no passenger was in the particular seating area of the vehicle. If the seat was not occupied when the corresponding airbag and/or seatbelt tensioner were activated, the system would activate, the result being economic waste with possible injury to one or more other vehicle occupants. There are known devices that deactivate an airbag or seatbelt tensioner activator if the seat is unoccupied or if the corresponding seatbelt is unlatched. However, many of these devices require complex electrical circuitry or require relatively large amounts of electrical power, through current leakage, in order to function properly.

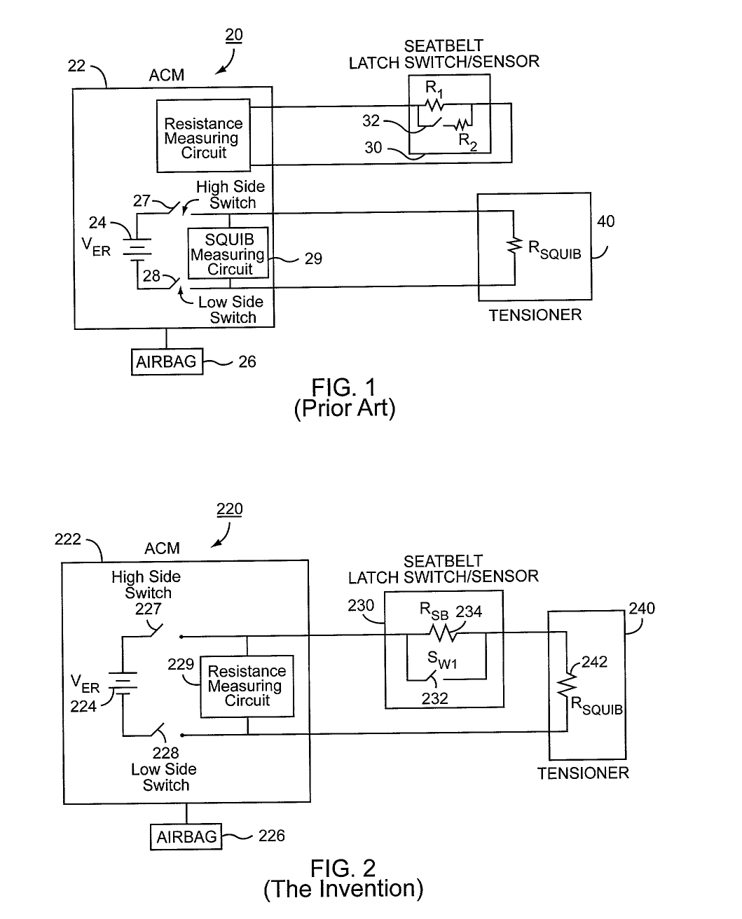

FIG. 1 discloses a seatbelt tensioning circuit typical of currently available commercial production airbag modules, e.g., Bosch AB 8.7 Airbag Control Module P/N 0 285 001 344 manufactured and sold by Robert Bosch Corporation. Airbag control system 20 includes an airbag control module 22, one or more seatbelt latch switches, and one or more ACM airbag deployment loop 26 and seatbelt tensioner squib loops 40, typically connected to the vehicle's power system. The airbag control module 22, seatbelt latch 30, airbag loop 26 and tension squib loop 40 are conventional equipment typically found in modern automobiles and other vehicles, such as trucks and buses, and are well known in the prior art.

The seatbelt latch switch module 30 includes a latch switch 32. The seatbelt switch 32 could be a separate switch that would be activated when the seatbelt is coupled together as when placed around a passenger. Conventional seatbelt latch switches are available commercially from a variety of suppliers, such as Takata, Cherry Automotive and Autoliv. Alternatively, but not preferred, the seatbelt latch switch 32 comprises the actual metal ends of the seatbelt itself which, when coupled together, electrically close the seatbelt latch switch through electrical wires in each half of the belts themselves. That is, the metal ends of the seatbelts could comprise the poles or contacts of a switch which, when coupled together, close and complete a circuit which is detected by the airbag control module as the switch being closed, i.e., fastened around a passenger.

The seatbelt tensioner squib 40 is a standard firing squib which, when fired in an accident or a crash, or as a result of a sudden deceleration, immediately causes the seatbelt to rewind with a result of an increase in tension across a passenger's body. This immediately eliminates the slack in the seatbelt system so that the seatbelt can restrain a passenger's movement quickly and effectively, preventing potentially dangerous body movement. In a collision, or other rapid deceleration, a sensor (not shown) in the airbag control module detects the rapid deceleration and, if the seatbelt buckle switch 32 is closed, or the seatbelt latch members are connected, denoting a passenger at that seat position, the airbag control module 22 sends a firing signal to the seatbelt tensioner squib 40 which causes the squib to fire, i.e., energize. This firing causes the seatbelt, which may not have been adequately tight about the passenger, to immediately tighten and draw shorter about the passenger. This increased tension prohibits or at least vastly reduces the forward motion of the passenger who is undergoing rapid deceleration due to the incurring collision. While the seatbelt squib 40 is firing, the airbag 26 may also deploy, thereby adding further safety protection to the passenger. High-side switch 27 and low-side switch 28 isolate the voltage supply 24 VER from the squib current. Squib resistance measuring circuit 29 will be discussed below in conjunction with FIG. 2.

However, having the seatbelt latch switch 30 on one circuit and the seatbelt tensioner squib 40 on another circuit is inefficient, less economical and introduces potential additional failure points. More wiring upon manufacture increases manufacturing costs, and more wiring after a collision increases repair costs. The present invention eliminates these extra and unnecessary costs.

FIG. 2 discloses the seatbelt sensor loop in accordance with the principles of the present invention. Airbag control system 220, as shown in FIG. 2, includes an airbag control module 222, one or more seatbelt latch switches 230, and one or more ACM deployment loops 226, 240 (airbag and tensioning loops, respectively). The airbag control module 222 may be standard equipment found in modem automobiles and other vehicles, such as trucks and buses, and are well known in the art. While an airbag control system 220 and control module 222 are shown in FIG. 2, any other device of the same type are inferred, such as an acceleration sensor device or curtain type side airbag (side screen) deployment systems.

The seatbelt latch switch module 230 includes a switch 232 that is connected in parallel to a resistor 234, R_{SB}. The seatbelt switch 232 may be a separate switch that would be activated when the seatbelt is coupled together as when placed around a passenger.

The seatbelt tensioner squib 240 in FIG. 2 is a standard seatbelt firing squib which, when fired in an accident, crash, or other rapid deceleration, immediately causes the seatbelt to rewind and increase its tension across a passenger's body. This immediately eliminates the slack in the seatbelt system so that the seatbelt can restrain a passenger's movement more quickly and effectively. The squib includes resistance 242, R_{SQUIB}, the internal impedance of the squib, typically 2 Ohms, and a pyrotechnic charge capable of initiating the airbag inflator or seatbelt tensioner.

As set forth above, the disadvantage of the prior art is that separate circuits are required to read and diagnose the seatbelt switch and the tensioner firing loop. This requires three to four wires and connector pins to physically implement. The present invention eliminates the need for a separate seatbelt switch interface circuit. By inserting the seatbelt switch into the tensioner firing loop as shown in FIG. 2, the existing squib 240 (including resistor 242 described below) and firing loop diagnostics can be used to read and diagnose the seatbelt switch. The resulting circuit can perform the same function with only two wires. Not only can the present invention prevent unnecessary firing or activation of the seatbelt tensioner, but may also be used to modify the activation of the airbag for that seat location as well. That is, the presence of an open switch 232 (or unbuckled seatbelt) functions as a positive diagnostic for the airbag control module 222.

In one embodiment, the open condition of switch 230 functions as an abort override to the airbag 226 activation, i.e., firing of the airbag(s) squib(s) for that seat. That is, if the latch switch 230 is unbuckled (switch 232 is open), the seatbelt tensioner for that seat is unable to deploy.

In another embodiment, the open condition of switch 232 is one more input to the airbag control module 222, or the AOS system (not shown). The occupancy state algorithm in either the ACM or the AOS evaluates this “open latch” or “open buckle” signal along with the other sensor signals, e.g., weight, mass or capacitance sensors in the seat, acceleration sensors, IR and/or US from the AOS module, and the like, to determine if there is a passenger in the seat. It can decide, in the case of an occupant in the seat with the belt unlatched, to fire the airbag squib, but not the seatbelt tensioner squib. Or the decision can be the converse, in the case of an MT (empty) signal from the seat or AOS sensors but a “closed” latch or buckle signal from the inventive latch switch, as where the belt is latched but no passenger is present, or the belt is secured around a package, the ACM can selectively fire the tensioner squib but not deploy the airbag(s) for that seat.

For more detail on AOS sensor systems and control algorithms, see U.S. Pat. Nos. 5,482,314; 5,890,085; 5,873,597; 5,860,674; 6,026,340; and U.S. Ser. No. 09/163,855 filed Sep. 30, 1998, the disclosures of which are hereby incorporated by reference to the extent needed for integration of the circuit of this invention into a vehicle safety system.

In FIG. 2, electrical switch 232 must be capable of carrying the required squib 240 firing current. Useful switch types include typical mechanical switches or magnetically actuated reed switches. A resistor R_{SB} 234 is placed in parallel with the switch 232 to allow diagnosis of this switch. The resistor R_{SB} is chosen such that if switch 232 is open, i.e., not shorting out the resistance thereof, the possible current through squib 240 will be limited to less than the specified “no fire current” of the squib, i.e., less than the current that would fire squib 240. By choosing a resistor R_{SB} in this manner, the airbag control module (ACM) 222 software does not require means to determine the state of the seatbelt switch 230 in order to disable the tensioner squib. If the ACM 222 attempts to fire the tensioner squib 240 while the switch 232 is open, resistor R_{SB} 234 acts as a choke to prevent the tensioner squib 240 from firing. Resistor 242 is the internal impedance of the squib, typically 2 Ohms. (A squib comprises such a resistor, and a pyrotechnic charge capable of initiating the airbag inflator or seatbelt tensioner.) Diagnostics of the apparatus are performed by passing a known current through the circuit. The diagnostic current (I_{d}) is chosen such that the voltage produced by the current across resistor 234 (R_{SB}) and resistor 242 (R_{SQUIB}) is less than the full-scale range of analog measurement of the ACM. The diagnostic current is a small current in the milliamp range passed through the firing loop by the ACM. This is usually done by a current source/sink. By passing a known current through the squib and measuring the voltage across the squib, its resistance can be determined.

When the seatbelt is buckled, the resistance R_{SQUIB} of the squib 240 can be measured by R_{SQUIB}=Vₒᵤₜ/I_{d}, where I_{d} is the test current and Vₒᵤₜ is the voltage measured at the ACM 222.

When the seatbelt is unbuckled, the output voltage can be used to determine if the circuit is operational or open circuit. Thus, the circuit can also determine the state of the seatbelt switch should that information be required by the ACM. Other circuit faults can be detected using the present invention, as well.

The value of resistor R_{SB} 234 is selected such that:

V_{ER}/(R_{SB}+R_{SQUIB})≦No fire current of squib 240, where V_{ER} is the maximum voltage that could be used to fire the squib.

The diagnostic current is selected such that:

I_{d}[R_{SB}+R_{SQUIB}]<The maximum voltage that the ACM can measure.

Industrial Applicability/Example:

As exemplary of the industrial applicability of the inventive circuit, the following example shows its applicability to integration of the tensioner circuit to an ACM. A current Airbag Control Module manufactured and marketed by Robert Bosch Corporation would include a voltage source VER=25 volts. As most vehicles have 12 volt systems, it is typical in airbag applications to have a charge pump voltage converter, not shown. This circuit takes the 12V ignition voltage from the vehicle and “pumps” it up to about 25V. The typical firing current of a squib may be several amps. Pumping up the firing voltage is the only way to overcome the system impedances and provide this amount of current. High-side switch 227 and low-side switch 228 isolate VER from the squib circuit until the time for squib firing.

For example, consider Bosch Model AB 8.7, Part No. 0 285 001 344, wherein the minimum resistance, R_{SQUIB} of the seatbelt tensioner squib is 1.0 ohms and has a guaranteed no-fire current of 100 mA. Utilizing resistance measuring circuit 229, resistor RsB is then calculated as follows:

V_{ER}/(R_{SB}+R_{SQUIB})≦100 mA

R_{SB}≧249 ohms.

The diagnostic current can be calculated for the same seatbelt tensioner squib as follows:

I_{d}(R_{SB}+R_{SQUIB})≦4.8 volts. Where 4.8 volts is the maximum voltage that this ACM can measure.

I_{d}(249+4.74 )≦4.8 volts

I_{d}<18.9 mA, where 4.74 Ohms is the maximum resistance of a normal squib.

Thus, when switch 232 is closed, the airbag control module 222 is able to pass current through resistor 242 that exceeds the threshold firing current I_{d}; and when switch 232 is open, the current through the R_{SQUIB} resistance 242 is less than the threshold current to fire the squib 240. If switch 232 is connected to, or forms part of a seatbelt latch 227, so that the switch is closed only if the seatbelt is latched, the seatbelt tensioner will be activated in a collision or other rapid deceleration only if the corresponding seatbelt is latched.

The inventive system has been described with reference to a single passenger seat and single seat airbag and seat tensioner system. However, the invention also has applicability to multiple passenger seats, whether the seat airbags and tensioners act independently, as with independent or bucket seats; or in concert, as with dual seat, such as in a bus or the back seat of an automobile.

It is clear that the inventive circuit has wide applicability as an improved seatbelt tensioner circuit that can be employed by itself as such in vehicles, or in combination with airbag control modules.

While embodiments and applications of this invention have been shown and described, it will be apparent to those skilled in the art having the benefit of this disclosure that many equivalents and other modifications are possible without departing from the inventive concepts herein. The invention, therefore, is not to be restricted except in the spirit of the appended claims.

1. A system for controlling activation of a seatbelt tensioner activator comprising:
a) an electrical circuit including a voltage source having first and second terminals with a selected voltage between the two terminals;
b) a seatbelt tensioner activator including a first resistor having a selected first resistance value;
c) a shunt circuit including an electrical switch, said electrical switch having negligible resistance when said switch is closed, and a second resistor, having a selected second resistance value, connected across said electrical switch, wherein said voltage source, said first resistor, and said shunt circuit are connected in series; and
d) said seatbelt tensioner activator having first and second activation terminals connected to a terminal of the voltage source and to a terminal of the electrical circuit, respectively; said seatbelt tensioner activator being activated only if a current at least equal to a selected threshold current passes through the activation circuit, and wherein the current in the electrical circuit is greater than the threshold current only if the shunt circuit switch is closed.

2. The system of claim 1, further comprising a seatbelt latch connected to said shunt circuit, wherein said electrical switch is closed when said seatbelt latch is closed.

3. The system of claim 1, further including a high-side switch and a low-side switch for isolating the voltage source from the electrical circuit.

4. The system of claim 1 wherein said first resistor having a selected first resistance value is the internal resistance of said seatbelt tensioner activator.

5. The system of claim 4 wherein said seatbelt tensioner activator is an electrically firing squib that is activated only when said electrical switch is closed.

6. A system for controlling activation of an airbag, the system comprising:
a) an electrical circuit including a voltage source having first and second terminals with a selected voltage between the two terminals;
b) a first resistor having a selected first resistance value;
c) a shunt circuit including an electrical switch, said electrical switch having negligible resistance when said switch is closed, and a second resistor, having a selected second resistance value, connected across said electrical switch, wherein said voltage source, said first resistor, and said shunt circuit are connected in series; and
d) an airbag activation circuit, attached to an airbag, having first and second activation terminals connected to a terminal of the voltage source and to a terminal of the electrical circuit, respectively; said airbag being activated only if a current at least equal to a selected threshold current passes through the activation circuit, and
e) wherein the current in the electrical circuit is greater than the threshold current only if the shunt circuit switched is closed.

7. A seatbelt tensioner control system comprising:
a) a control module including a power source,
b) a seatbelt latch switch in series with said power source,
c) a first resistor connected across said seatbelt latch switch,
d) a seatbelt tensioner in series with said control module, said power source, and said seatbelt latch switch, and
e) said seatbelt tensioner having a predetermined internal resistance and being activated only when said seatbelt latch switch is closed.

8. The seatbelt tensioner control system of claim 7, wherein said seatbelt tensioner includes a squib, which, when activated, causes the seatbelt to reel in any excess slack in the seatbelt, thereby increasing the seatbelt tension.

9. The seatbelt tensioner control system of claim 8, wherein the said first resistor is selected in accordance with the following relationship:
V_{ER}/(R_{SB}+R_{SQUIB})≦no activation of the seatbelt squib
wherein:
R_{SB} is the value of said first resistor,
R_{SQUIB} is a predetermined internal resistance of said seatbelt tensioner, and
V_{ER} is the voltage across R_{SQUIB}.

10. The seatbelt tensioner control system of claim 9, wherein the diagnostic current in said tensioner control system is determined in accordance with the following relationship:
I_{d}=V_{ER}/(R_{SB}+R_{SQUIB}),
wherein:
I_{d} is the diagnostic current.

11. A method for controlling activation of a seatbelt tensioner comprising the steps of:
a) providing an electrical circuit including:
i) a voltage source having first and second terminals with a selected voltage between the two terminals;
ii) a seatbelt tensioner activator including a first resistor having a selected first resistance value, and
iii) a shunt circuit including an electrical switch, having negligible resistance when the switch is closed,
iv) a second resistor having a selected second resistance value,
v) said voltage source, said first resistor, and said shunt circuit are connected in series; and
vi) said seatbelt tensioner activator having first and second activation terminals connected to a terminal of the voltage source and to a terminal of the electrical circuit, respectively; and
b) activating said seatbelt tensioner activator only if a current at least equal to a selected threshold current passes through said activation circuit, wherein the current in the electrical circuit is greater than the threshold current only if the shunt circuit switch is closed.

12. The method of claim 11 further comprising providing a seatbelt latch connected to said shunt circuit, wherein said switch is closed if and only if said seatbelt latch is closed.

13. The method of claim 12 further comprising choosing said first and second resistance values so that said current passing through said activation current when said switch is closed is on the order of about 50 times as large as said current passing through said activation circuit when said switch is open.

14. A method for controlling activation of an airbag comprising the steps of:
a) providing an electrical circuit comprising a voltage source having first and second terminals with a selected voltage between the two terminals, a first resistor having a selected first resistance value, and a shunt circuit, the shunt circuit comprising an electrical switch having negligible resistance when the switch is closed, in a first shunt arm and a second resistor having a selected second resistance value, where the voltage source, the first resistor and the shunt circuit are connected in series;
b) providing an airbag activation circuit, attached to an airbag, having first and second activation terminals connected to a terminal of the voltage source and to a terminal of the electrical circuit, respectively; and
c) activating the airbag only if a current at least equal to a selected threshold current passes through said activation circuit, where the current in the electrical circuit is greater than the threshold current only if the shunt circuit switched is closed.

15. The seatbelt tensioner control system of claim 7 further including a high-side switch and low-side switch for isolating the power source from the control system.

16. The method of claim 11 further including a high-side switch and a low-side switch for isolating the power source from the electrical circuit.
